(19) United States
(12) Patent Application Publication
(10) Pub. No.: US 2025/0077414 A1
(43) Pub. Date: Mar. 6, 2025

(54) SOLID-STATE STORAGE DEVICE AND METHOD FOR FETCHING COMMANDS THEREOF

(71) Applicant: KIOXIA CORPORATION, Tokyo (JP)

(72) Inventors: Yi Chiang WANG, Hsinchu (TW); Cheng Chan HE, Hsinchu (TW)

(73) Assignee: KIOXIA CORPORATION, Tokyo (JP)

(21) Appl. No.: 18/678,386

(22) Filed: May 30, 2024

(30) Foreign Application Priority Data
Sep. 1, 2023 (CN) 202311121986.3
Sep. 1, 2023 (TW) 112133296

(51) Int. Cl. G06F 12/02; G06F 12/0802

(52) U.S. Cl. CPC G06F 12/0246; G06F 12/0802

(57) ABSTRACT

A solid-state storage device is provided. The solid-state storage device is electrically connected to a host. The solid-state storage device includes a controller, a cache memory, a volatile memory, and a non-volatile memory. The cache memory, the volatile memory, and the non-volatile memory are electrically connected to the controller. The cache memory includes a first region and a second region. The controller is configured to fetch an access command from the host, and to store the access command in the first region. The controller is further configured to back up the access command stored in the first region to the volatile memory. The controller is further configured to store the access command backed up in the volatile memory in the second region, and to execute the access command stored in the second region.

### CROSS-REFERENCE TO RELATED APPLICATION(S)

The present application is based on, and claims priority from, Taiwan Application Serial Number 112133296, filed on Sep. 1, 2023, and China Application Serial Number 202311121986.3, filed on Sep. 1, 2023, the disclosures of which are hereby incorporated by reference in their entirety.

### FIELD OF THE DISCLOSURE

The present disclosure relates to solid-state storage devices, and, in particular, to a solid-state storage device and a method for fetching commands thereof.

### BACKGROUND

Solid-state storage devices utilize non-volatile memories for data storage and have become increasingly prevalent in various computer systems as technology has advanced. However, the service life of the non-volatile memory is directly impacted by the frequency of data read and write operations. When a host seeks to send a large number of access commands to a traditional solid-state storage device, the device may struggle to continuously retrieve access commands due to its limited hardware resources, potentially leading to device failure. This is because the cache memory becomes occupied by access commands that have been fetched but not yet executed, ultimately reducing the write or read performance of the solid-state storage device.

### SUMMARY OF THE DISCLOSURE

Accordingly, a solid-state storage device and a method for fetching commands thereof are provided in the present disclosure to address the aforementioned issues.

In an aspect of the present disclosure, a solid-state storage device is provided. The solid-state storage device is electrically connected to a host. The solid-state storage device includes a controller, a cache memory, a volatile memory, and a non-volatile memory. The cache memory, the volatile memory, and the non-volatile memory are electrically connected to the controller. The cache memory includes a first region and a second region. The controller is configured to fetch an access command from the host, and to store the access command in the first region. The controller is further configured to back up the access command stored in the first region to the volatile memory. The controller is further configured to store the access command backed up in the volatile memory in the second region, and to execute the access command stored in the second region.

In another aspect of the present disclosure, a method for fetching commands for use in a solid-state storage device is provided. The solid-state storage device is electrically connected to a host. The solid-state storage device includes a controller, a cache memory, a volatile memory, and a non-volatile memory. The method includes the following steps: utilizing the controller to fetch an access command from the host, and to store the access command in a first region of the cache memory; utilizing the controller to back up the access command stored in the first region to the volatile memory; and utilizing the controller to store the access command backed up in the volatile memory in a second region of the cache memory, and to execute the access command stored in the second region.

### BRIEF DESCRIPTION OF THE DRAWINGS

Aspects of the present disclosure are best understood from the following detailed description when read with the accompanying figures. It is noted that in accordance with the standard practice in the industry, various features are not drawn to scale. In fact, the dimensions of the various features may be arbitrarily increased or reduced for clarity of discussion.

FIG. 1 is a block diagram illustrating a computer system in accordance with an embodiment of the present disclosure.

FIG. 2A is a diagram illustrating the cache memory in accordance with an embodiment of the present disclosure.

FIGS. 2B-2D are diagrams illustrating usage scenarios of the cache memory in accordance with the embodiment of FIG. 2A of the present disclosure.

FIG. 3A is a diagram of a cache memory in accordance with another embodiment of the present disclosure.

FIGS. 3B and 3C are diagrams illustrating usage scenarios of the cache memory in the embodiment of FIG. 3A of the present disclosure.

FIG. 4 is a diagram illustrating a command fetching and command execution process of a solid-state storage device in accordance with an embodiment of the present disclosure.

FIG. 5 is a flowchart of a method for fetching commands for use in a solid-state storage device in accordance with an embodiment of the present disclosure.

FIG. 6 is a diagram of a cache memory in accordance with yet another embodiment of the present disclosure.

### DETAILED DESCRIPTION

The following description is for the purpose for describing preferred embodiments of the present disclosure, with the aim of describing the basic spirit of the present disclosure, but not to limit the present invention. The actual content of the invention should be referred to the appended claims.

It should be understood that the words “comprising” and “including” used in this specification are used to indicate the existence of specific technical features, numerical values, method steps, work processes, elements and/or components, but not to exclude additional technical features, numerical values, method steps, operations, elements, components, or any combination thereof.

The use of words such as “first,” “second,” and “third” in the scope of the patent application are used to modify the elements in the scope of the patent application, and are not used to indicate the priority order or precedence relationship between them, one component preceding another component, or the time sequence in which method steps are executed, and are only used to distinguish components with the same name.

The term “configured to” may describe or claim that various units, circuits, or other components are “configured to” perform a task or tasks. In such contexts, the term “configured to” implies that the units/circuits/components include a structure (e.g., circuitry) that performs their task(s) during operation. Thus, a specified unit/circuit/component may be said to be configured to perform the task even when the unit/circuit/component is not currently operating (e.g., not turned on). Such units/circuits/components accompanied by the term “configured to” include hardware—for example: circuits, memory (which stores program commands that are executable to perform operations), etc. Additionally, “configured to” may include a generic structure (e.g., general circuitry) that is manipulated by software and/or firmware (e.g., an FPGA or a general-purpose processor executing the software) to operate in a manner that enables the execution of the task(s) to be solved. Further, “configured to” may include adapting a manufacturing process (e.g., a semiconductor manufacturing equipment) to produce a device (e.g., an integrated circuit) adapted to perform one or more tasks.

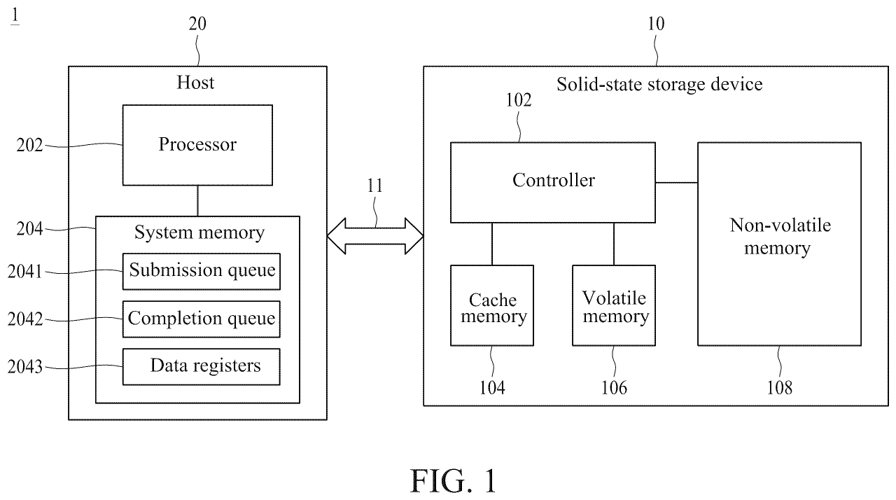

FIG. 1 is a block diagram illustrating a computer system in accordance with an embodiment of the present disclosure.

As shown in FIG. 1, the computer system 1 may include a solid-state storage device 10 and a host 20. The solid-state storage device 10 may be electrically connected to the host 20 through bus 11 for command and data transmission. In some embodiments, bus 11 may be a Universal Serial Bus (USB), a Serial Advanced Technology Attachment (SATA) bus, or a Peripheral Component Interconnect Express (PCI Express, PCIe) bus, etc., but the present disclosure is not limited thereto.

The solid-state storage device 10 may include a controller 102, a cache memory 104, a volatile memory 106, and a non-volatile memory 108. The controller 102 may be electrically connected to the cache memory 104, the volatile memory 106, and the non-volatile memory 108, and used to control data access of the cache memory 104, the volatile memory 106, and the non-volatile memory 108. In some embodiments, the controller 102 may be, for example, a general-purpose processor, a microcontroller, an application-specific integrated circuit (ASIC), or a field programmable gate array (FPGA), etc., but the present disclosure is not limited thereto.

The cache memory 104 may include, for example, a static random access memory (SRAM). The volatile memory 106 may include a dynamic random access memory (DRAM), but the present disclosure is not limited thereto. In some embodiments, the cache memory 104 and the volatile memory 106 can be disposed outside the controller 102. In some other embodiments, the cache memory 104 and the volatile memory 106 may be integrated into the controller 102. The non-volatile memory 108 may be a NAND flash memory configured to store the write data provided by the host 20.

The host 20 may include, for example, a processor 202 and a system memory 204, and the processor 202 is electrically connected to the system memory 204. In some embodiments, the processor 202 may include, for example, a central processing unit, a general-purpose processor, a microprocessor, etc., but the present disclosure is not limited thereto. In addition, the processor 202 may include a controller (not shown) for controlling data access to the system memory 204. The system memory 204 may include, for example, a dynamic random access memory, but the present disclosure is not limited thereto.

In some embodiments, the host 20 can support the Non-Volatile Memory Express (NVM Express, NVMe) protocol, and the system memory 204 may be equipped with a submission queue 2041, a completion queue 2042, and data registers 2043. The submission queue 2041 may be configured to record the access commands issued by the processor 202, and the completion queue 2042 may be configured to record the statuses of the completed access commands responded by the solid-state storage device 10. The data registers 2043 may be configured to store data that is to be written to the solid-state storage device 10 by the host 20 and to store data that is read from the solid-state storage device 10 by the host 20.

In some embodiments, the solid-state storage device 10 may support the NVMe protocol. The controller 102 may retrieve access commands from the submission queue 2041 of the host 20, such as write commands, read commands, etc., and store the fetched access commands in the cache memory 104.

The non-volatile memory 108 may include a plurality of blocks, and each block may include a plurality of pages. For example, non-volatile memory 108 can include 1024 blocks, and each block can include 64 pages, with capacity of each page 16 KB and each block 1 MB. The aforementioned data is for purposes of description, and the manufacturer of the non-volatile memory 108 can determine the number of pages in each block and the capacity of each page.

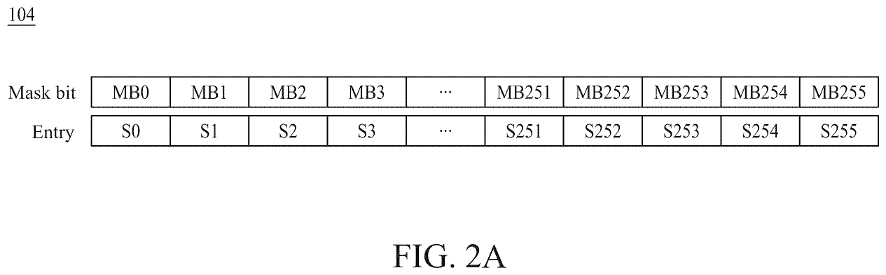

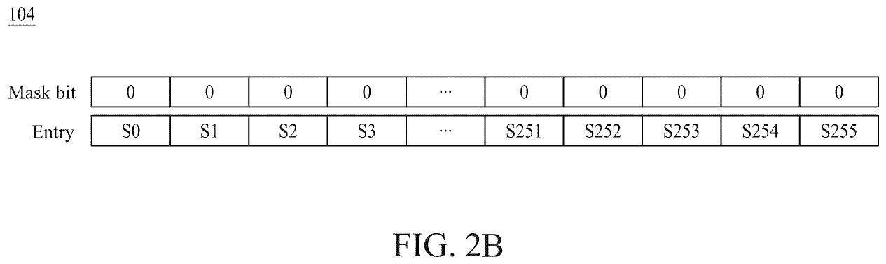

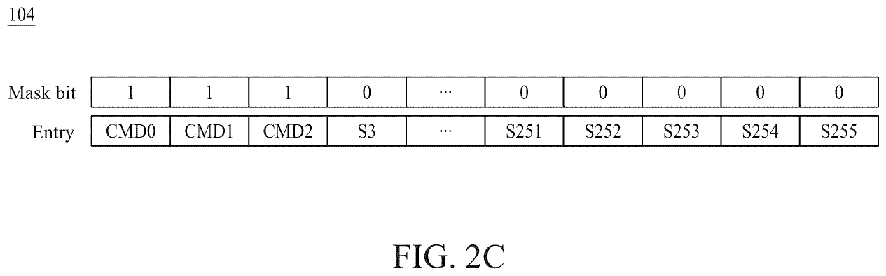

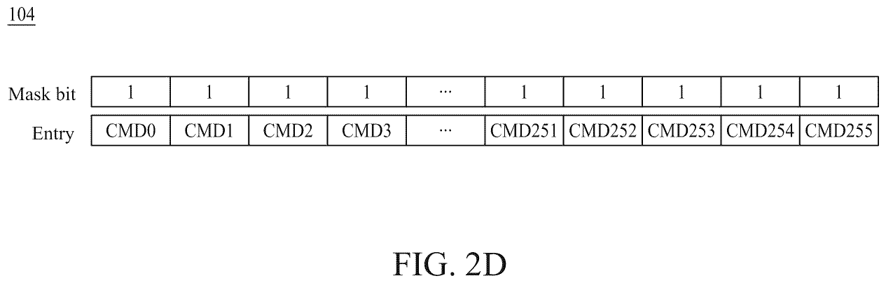

FIG. 2A is a diagram illustrating the cache memory in accordance with an embodiment of the present disclosure. FIGS. 2B-2D are diagrams illustrating usage scenarios of the cache memory in accordance with the embodiment of FIG. 2A of the present disclosure.

In some embodiments, compared to the number of access commands (e.g., up to 64K) that can be stored in the submission queue 2041 of the host 20, the capacity of the cache memory 104 of the solid-state storage device 10 is usually limited, resulting in a similarly limited number of access commands that the cache memory 104 can store. In some embodiments, the cache memory 104 includes 256 entries S0 to S255, and each entry S0 to S255 has a corresponding mask bit MB0 to MB255. The controller 102 determines whether to store the access commands fetched from the submission queue 2041 of the host 20 in the empty entries S0 to S255 based on the value of each mask bit MB0 to M255. It should be noted that the number of entries within the cache memory 104 may vary depending on its actual capacity, and the 256 entries within the aforementioned embodiment are for purposes of description, but the present disclosure is not limited thereto.

For example, in the NVMe standard, the command size of an access command is fixed at 64 bytes, and the size of each entry within the submission queue 2041 also matches the fixed command size. In addition, the size of each entry within the cache memory 104 also matches the fixed command size.

In some embodiments, when the value of the mask bit corresponding to a specific entry is 0, it indicates that the specific entry is an empty entry. Accordingly, the controller 102 may store an access command fetched from the submission queue 2041 of the host 20 to the specific entry. When the value of the mask bit corresponding to a specific entry is 1, it indicates that the specific entry has been occupied or masked. Accordingly, when the controller 102 fetches an access command from the submission queue 2041 of the host 20, the controller 102 will not store the fetched access command in the specific entry.

In some embodiments, when the solid-state storage device 10 is booted up, each entry S0 to S255 in the cache memory 104 is an empty entry, and the value of the corresponding mask bit of each entry S0-S255 is 0, as shown in FIG. 2B. After the controller 102 fetches one or more access commands from the submission queue 2041 of the host 20, the controller 102 writes each of the one or more fetched access commands into an empty entry within the cache memory 104 sequentially. For example, starting from entry S0, the controller 102 writes the fetched access commands CMD0 to CMD2 to entries S0, S1 and S2, and modifies the values of corresponding mask bits MB0, MB1 and MB2 of entries S0, S1 and S2 to 1, as shown in FIG. 2C. When the number of access commands fetched by the controller 102 from the submission queue 2041 of the host 20 is sufficient, each entry S0 to S255 in the cache memory 104 will store an access command (e.g., access commands CMD0 to CMD255), and the value of the corresponding mask bit value of each entry S0 to S255 will be modified to 1, as shown in FIG. 2D.

However, when the situation in FIG. 2D occurs, it indicates that all entries within the cache memory 104 have been occupied, so the controller 102 cannot retrieve access commands from the submission queue 2041 of the host 20 at this time. In addition, not all of the entries S0 to S255 in the cache memory 104 are used to temporarily store access commands, but some entries are used for the command-execution phase and the command-completion phase. Therefore, the number of entries within the cache memory 104 available for temporarily storing access commands will be less than 256.

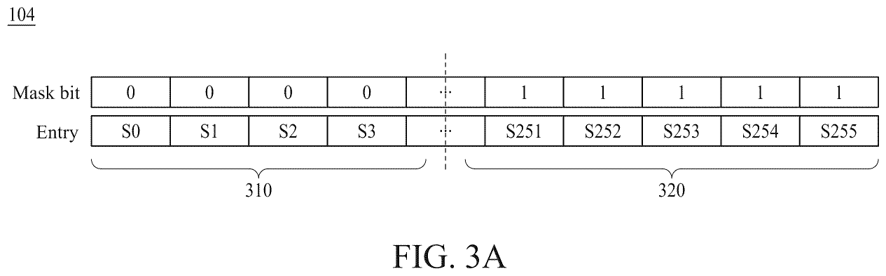

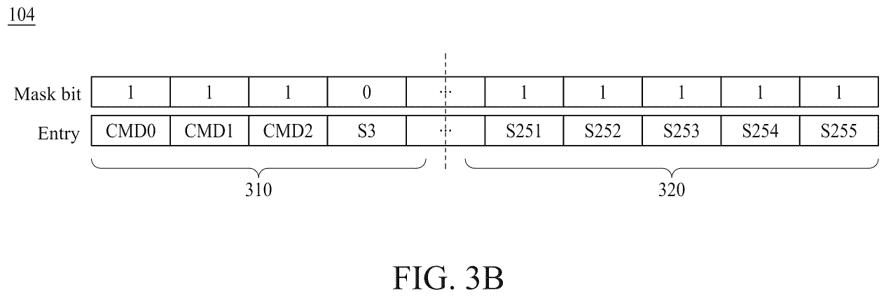

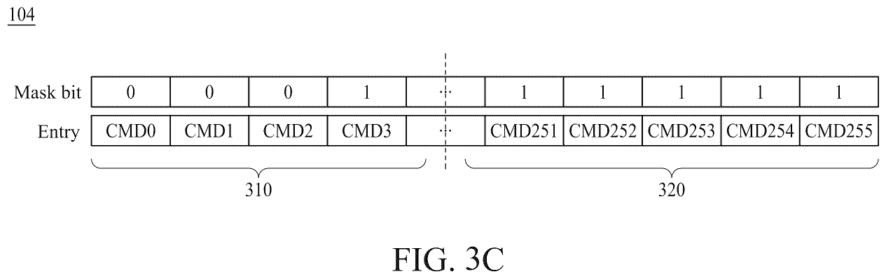

FIG. 3A is a diagram of a cache memory in accordance with another embodiment of the present disclosure. FIGS. 3B and 3C are diagrams illustrating usage scenarios of the cache memory in the embodiment of FIG. 3A of the present disclosure.

In some embodiments, the cache memory 104 can be divided into a command-fetching region 310 and a command-execution region 320. The command-fetching region 310 is used to store access commands fetched by the controller 102 from the submission queue 2041 of the host 20. The command-execution region 320 is used to store one or more access commands executed by the controller 102 during the command-execution phase, and the command-execution region 320 can also be regarded as a submission queue of the solid-state storage device 10. Specifically, when the solid-state storage device 10 is booted up, the controller 102 may configure a first portion and a second portion of the 256 entries S0 to S255 in the cache memory 104 as the command-fetching region 310 and the command-execution region 320, respectively. The number of entries within the command-fetching region 310 and the command-execution region 320 can be adjusted according to practical conditions.

Specifically, when the solid-state storage device 10 is booted up, each entry within the command-fetching region 310 and the command-execution region 320 is an empty entry. The controller 102 may initialize the value of the mask bit corresponding to each entry within the command-fetching region 310 to 0 (e.g., a first value), and initialize the value of the mask bit corresponding to each entry within the command-execution region 320 to 1 (e.g., a second value), as shown in FIG. 3A. After the value of the mask bit corresponding to each entry within the command-execution region 320 is initialized, the controller 102 will no longer modify the value of the mask bit corresponding to any entry within the command-execution region 320. That is, the value of the mask bit corresponding to each entry within the command-execution region 320 will be maintained at 1. Therefore, when the controller 102 fetches an access command from the submission queue 2041 of the host 20, the controller 102 does not store the fetched access command within the command-execution region 320.

When the controller 102 fetches one or more access commands (e.g., access commands CMD0, CMD1, and CMD2) from the submission queue 2041 of the host 20, the controller 102 will write each of the one or more fetched memory access commands to an empty entry within the command-fetching region 310 sequentially. For example, starting from entry S0, the controller 102 writes the fetched access commands to entries S0, S1 and S2, and modifies the values of the mask bits corresponding to entries S0, S1, and S2 to 1, as shown in FIG. 3B. It should be noted that during the aforementioned process for storing the fetched access command, the value of the mask bit corresponding to each entry within the command-execution region 320 is maintained at 1.

When the controller 102 writes the one or more fetched access commands to empty entries of the command-fetching region 310 one by one, the controller 102 also backs up the access commands stored in the command-fetching region 310 to the volatile memory 106, for example, by using a one-by-one backup or batch backup method. As shown in FIG. 3C, in addition to writing the fetched access command CMD3 to entry S3 and modifying its corresponding mask bit value, the controller 102 also backs up the access commands CMD0 to CMD2 previously stored in entries S0 to S2 to the volatile memory 106, and modifies the mask bit values MB0 to MB2 corresponding to entries S0 to S2 to 0. In some embodiments, when the controller 102 backs up an access command stored in the command-fetching region 310 to the volatile memory 106, the controller 102 may modify the value of the mask bit corresponding to the entry of the access command to 0 to indicate that the entry is empty, and a subsequent fetched access command can be written to that entry. In other embodiments, when the controller 102 backs up the access commands stored in the command-fetching region 310 to the volatile memory 106, the controller 102 may clear the content of the entry of the access command and modify the value of the mask bit corresponding to the entry of the access command to 0.

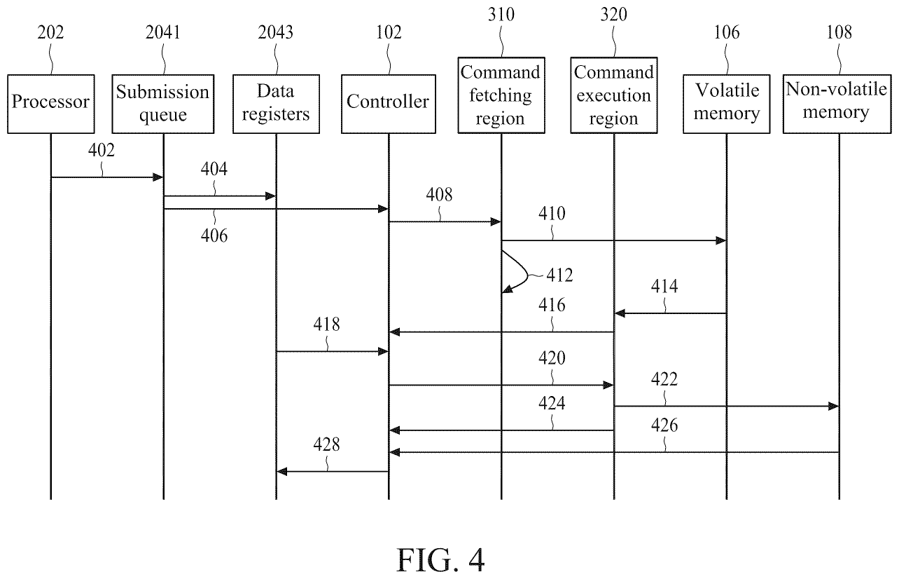

FIG. 4 is a diagram illustrating a command fetching and command execution process of a solid-state storage device in accordance with an embodiment of the present disclosure. Please refer to FIG. 1, FIG. 3A and FIG. 4 at the same time.

When the processor 202 issues an access command (e.g., a write command or a read command), the processor 202 writes the access command to the submission queue 2041 (arrow 402). When the access command is a write command, the processor 202 writes the data corresponding to the access command into the data registers 2043 (arrow 404). The controller 102 of the solid-state storage device 10 will periodically check whether any new access command has been submitted to the submission queue 2041. When there is a new access command in the submission queue 2041, the controller 102 fetches the newly submitted access command from the submission queue 2041 (arrow 406), and stores the fetched access command in the command-fetching region 310 of the cache memory 104 (arrow 408).

The controller 102 then backs up the access commands stored in the command-fetching region 310 to the volatile memory 106 (arrow 410), and clears the values of the mask bits corresponding to the entries of the backed-up access commands (arrow 412). The aforementioned operations of arrows 410 and 412 can be performed repeatedly. When the controller 102 enters the command-execution phase to execute the access command, the controller 102 writes one or more access commands backed up to the volatile memory 106 to the command-execution region 320 of the cache memory 104 (arrow 414), and reads and executes one of the access commands from the command-execution region 320 (arrow 416). When the executed access command is a write command, the controller 102 will retrieve the write data corresponding to the access command from the data registers 2043 of the host 20 (arrow 418), and store the write data in the cache memory 104 (e.g., command-execution region 320) (arrow 420). The controller 102 then programs the write data stored in the cache memory 104 into the non-volatile memory 108 (arrow 422).

When the access command to be executed is a read command, the controller 102 also reads and executes the access command from the command-execution region 320 (arrow 424). When the data of the access command is not temporarily stored in the cache memory 104 or the volatile memory 106, the controller 102 reads the read data corresponding to the access command from the non-volatile memory 108 (arrow 426), and writes the read data in the data registers 2043 of the host 20 (arrow 428).

It should be noted that although the completion queue 2042 of the host 20 is not shown in the flow of FIG. 4, when the controller 102 completes an access command (e.g., a write command or a read command), the controller 102 writes the command completion information of the access command to a completion queue in the cache memory 104 (not shown in FIG. 1), and then deletes the completed access command from a submission queue (not shown in FIG. 1) of the cache memory 104. Then, the controller 102 writes the command completion information of the completed access command to the completion queue 2042 of the host 20, and deletes the completed access command from the submission queue 2041 of the host 20.

In some embodiments, a plurality of access commands issued by the processor 202 of the host 20 may be a plurality of write commands for sequential writes to the solid-state storage device 10, or a plurality of read commands for sequential reads from the solid-state storage device 10. However, because the operating system (not shown) running on the host 20 may need to write the system log file to the solid-state storage device 10 or read the system log file from the solid-state storage device 10 at any time, the write commands or read commands for the system log file may be interspersed between sequential write commands or read commands. In this case, the controller of a conventional solid-state storage device will determine that the access commands are random write commands or random read commands, which will affect the write or read performance of the conventional solid-state storage device. However, through the design of the command-fetching region 310 and the command-execution region 320 of the cache memory 104 of the present disclosure, the controller 102 can back up the access commands stored in the command-fetching region 310 to the volatile memory 106, and store the access commands to be executed in the command-execution region 320 during the command-execution phase. Therefore, the controller 102 not only continuously fetches new access commands from the submission queue 2041 of the host 20, but also filters out the write commands for the system log file issued by the host 20 from the access commands already backed up in the volatile memory 106, so that the subsequent to-be-executed access commands stored in the command-execution region 320 can form write commands for sequential writes, thereby improving the performance of the solid-state storage device 10.

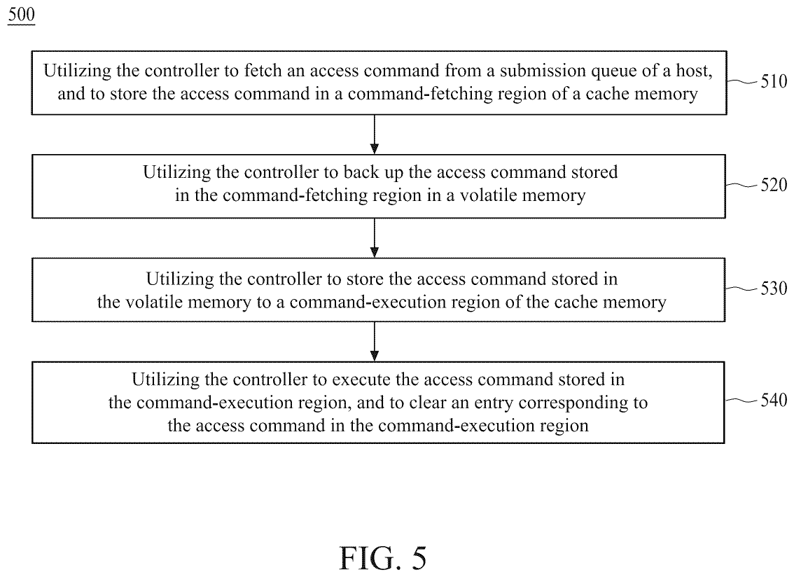

FIG. 5 is a flowchart of a method for fetching commands for use in a solid-state storage device in accordance with an embodiment of the present disclosure. Please refer to FIG. 1, FIG. 3A and FIG. 5 at the same time.

In step 510, the controller 102 fetches an access command from the submission queue 2041 of the host 20, and stores the access command in the command-fetching region 310 of the cache memory 104. For example, the cache memory 104 can be divided into a command-fetching region 310 and a command-execution region 320. The command-fetching region 310 is used to store access commands fetched by the controller 102 from the submission queue 2041 of the host 20. The command-execution region 320 is used to store one or more access commands executed by the controller 102 during the command-execution phase.

In step 520, the controller 102 backs up the access commands stored in the command-fetching region 310 to the volatile memory 106. For example, the processor 202 of the host 20 may issue a large number of access commands and store the access commands in the submission queue 2041. In addition, before the controller 102 of the solid-state storage device 10 executes the access commands, the controller 102 needs to first store the access commands fetched from the submission queue 2041 in the command-fetching region 310 of the cache memory 104. However, the capacity of the command-fetching region 310 is limited, so when the controller 102 writes the access commands fetched from the submission queue 2041 to the command-fetching region 310, the controller 102 also backs up the access commands already stored in the command-fetching region 310 to the volatile memory 160, and clears the values (e.g., set to 0) of the mask bits corresponding to the entries of the backed-up access commands to clear the occupied entries within the command-fetching region 310 as empty entries, so the controller 102 can further fetch more access commands from the submission queue 2041 of the host 20. In an embodiment, the backed-up access command is the same as the access command just fetched from the submission queue 2041 of the host 20, that is, when the controller 102 stores the access command fetched from the submission queue 2041 to the command-fetching region 310 of the cache memory 104, the controller 102 synchronously backs up the access command to the volatile memory 106. In an embodiment, the backed-up access command is different from the access command just fetched from the submission queue 2041 of the host 20, that is, the access command backed up by the controller 102 is an access command previously stored in the command-fetching region 310 rather than the access command just fetched from the submission queue 2041 of the host 20.

In step 530, the controller 102 stores the access commands stored in the volatile memory 106 in the command-execution region 320 of the cache memory 104. For example, when the controller 102 enters the command-execution phase to execute the access commands, the controller 102 writes the access command backed up to the volatile memory 106 to the command-execution region 320 of the cache memory 104, and reads and executes one of the access commands from the command-execution region 320.

In step 540, the controller 102 executes the access command stored in the command-execution region 320, and clears the entry corresponding to the access command in the command-execution region 320.

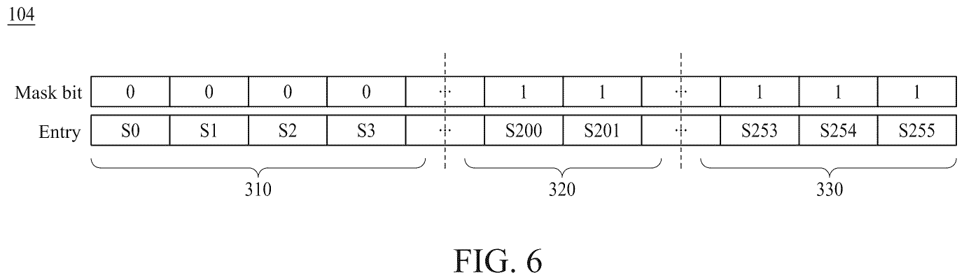

FIG. 6 is a diagram of a cache memory in accordance with yet another embodiment of the present disclosure.

In some embodiments, the cache memory 104 can be divided into a command-fetching region 310, a command-execution region 320, and a command-completion region 330. Details for the functions of the command-fetching region 310 and the command-execution region 320 can be referred to the embodiments of FIG. 3A. The command-completion region 330 is used to store command completion information of access commands that have been executed by the controller 102 in the command-execution region 320. Accordingly, the command-completion region 330 can also be regarded as a completion queue of the solid-state storage device 10. The number of entries within the command-fetching region 310, the command-execution region 320, and the command-completion region 330 can be adjusted according to practical conditions.

Specifically, the design of the cache memory 104 in FIG. 6 can further divide the procedure for performing an access command into the command-fetching phase, the command-execution phase, and the command-completion phase, and the command-completion stage has an individual command-completion region 330 that is used to store the command completion information of the completed access commands, without mixing the command completion information with the access commands to be executed in the command-execution region 320. Therefore, in some cases, the design of the cache memory 104 in FIG. 6 can further improve the performance of the solid-state storage device 10.

Although the present disclosure is disclosed above with preferred embodiments, they are not intended to limit the scope of the present disclosure. Persons of ordinary skill in the art can make some modifications without departing from the spirit and scope of the present disclosure. Therefore, the scope of the present disclosure shall be determined by the appended claims.

What is claimed is:

1. A solid-state storage device configured to be electrically connected to a host, the solid-state storage device comprising:
a controller;
a cache memory, electrically connected to the controller, wherein the cache memory comprises a first region and a second region;
a volatile memory, electrically connected to the controller; and
a non-volatile memory, electrically connected to the controller;
wherein the controller is configured to fetch an access command from the host, and to store the access command in the first region;
wherein the controller is configured to back up the access command stored in the first region to the volatile memory; and
wherein the controller is configured to store the access command backed up in the volatile memory in the second region, and to execute the access command stored in the second region.

2. The solid-state storage device of claim 1, wherein the first region is a command-fetching region, and the second region is a command-execution region.

3. The solid-state storage device of claim 1, wherein:
the first region comprises a plurality of first entries, and each of the plurality of first entries corresponds to a first mask bit; and
the second region comprises a plurality of second entries, and each of the plurality of second entries corresponds to a second mask bit.

4. The solid-state storage device of claim 3, wherein when the solid-state storage device is booted up, the controller initializes a value of the first mask bit corresponding to each first entry to a first value, and initializes a value of the second mask bit corresponding to each second entry to a second value.

5. The solid-state storage device of claim 4, wherein the controller is configured to write the access command fetched from the host to one of the first entries, and to modify the value of the first mask bit corresponding to the first entry, to which the access command is written, to the second value.

6. The solid-state storage device of claim 5, wherein when the controller backs up the access command stored in the first region to the volatile memory, the controller is further configured to modify the value of the first mask bit corresponding to the first entry of the backed-up access command to the first value.

7. The solid-state storage device of claim 1, wherein the cache memory further comprises a third region for storing command completion information of the access command that has been executed in the second region.

8. A method for fetching commands, for use in a solid-state storage device, wherein the solid-state storage device is electrically connected to a host and comprises a controller, a cache memory, a volatile memory, and a non-volatile memory, the method comprising:
utilizing the controller to fetch an access command from the host, and to store the access command in a first region of the cache memory;
utilizing the controller to back up the access command stored in the first region to the volatile memory; and
utilizing the controller to store the access command backed up in the volatile memory in a second region of the cache memory, and to execute the access command stored in the second region.

9. The method of claim 8, wherein the first region is a command-fetching region, and the second region is a command-execution region.

10. The method of claim 8, wherein:
the first region comprises a plurality of first entries, and each of the plurality of first entries corresponds to a first mask bit; and
the second region comprises a plurality of second entries, and each of the plurality of second entries corresponds to a second mask bit.

11. The method of claim 10, further comprising: when the solid-state storage device is booted up, utilizing the controller to initialize a value of the first mask bit corresponding to each first entry to a first value, and to initialize a value of the second mask bit corresponding to each second entry to a second value.

12. The method of claim 11, further comprising: utilizing the controller to write the access command fetched from the host to one of the first entries, and to modify the value of the first mask bit corresponding to the first entry, to which the access command is written, to the second value.

13. The method of claim 12, further comprising: when the controller backs up the access command stored in the first region to the volatile memory, utilizing the controller to modify the value of the first mask bit corresponding to the first entry of the backed-up access command to the first value.

14. The method of claim 8, wherein the cache memory further comprises a third region for storing command completion information of the access command that has been executed in the second region.
